(19) United States
(12) Patent Application Publication
(10) Pub. No.: US 2012/0318040 A1
(43) Pub. Date: Dec. 20, 2012

(54) SYSTEM AND METHOD OF DETECTING HEAD GASKET DEGRADATION

(76) Inventor: Clifford Kratzet, Metamora, MI (US)

(21) Appl. No.: 13/161,531

(22) Filed: Jun. 16, 2011

(51) Int. Cl. G01M 15/04

(52) U.S. Cl. 73/23.31

(57) ABSTRACT

A system and method of detecting a degraded head gasket in an engine. The detection of a combustible product in the coolant of a cooling system for the engine is used to indicate a degraded head gasket. The combustible product detection is facilitated by deaerating the engine coolant in a dearating tank. Gases extracted from the coolant in the deaerating tank are sampled and detected by a combustible product sensor, which outputs a signal if the combustible product is detected.

### FIELD

The present disclosure relates to a system and method for detecting head gasket degradation in an engine, and more particularly to a system and method for monitoring a level of a combustible product in coolant to indicate degradation of a head gasket.

### BACKGROUND

Quality control tests are widely used to ensure that specific components of a vehicle engine function properly and are not defective. One such engine component that may be tested is an engine head gasket. Primarily, a head gasket is tested to ensure that it seals properly and is structurally sound. A cracked head gasket or a breach in the head gasket seal can result in the leakage of combustion products from the associated cylinder into the surrounding coolant jacket. One test used to determine the structural integrity and seal of a head gasket in a new engine is performed by injecting nitrogen into the cylinders of the engine at high pressures (“nitro-checks”). Over time varying from hours to days, the nitrogen-charged system is checked for leaks. Nitrogen leaks near the head gasket may indicate that the head gasket is defective. The process of injecting the nitrogen into the combustion chamber, checking for leaks, and purging the system of nitrogen can be labor and time intensive. Therefore, an alternative to nitro checks is desired.

### SUMMARY

In one form, the present disclosure provides a system for detecting a degraded head gasket in an engine. The system includes a cooling tower, a deaerating tank and a combustible product sensor. The cooling tower includes input and output ports that are coupled to the engine's cooling system via a bypass valve. The input and output ports allow coolant from the engine to be cooled by the cooling tower. The deaerating tank also includes input and output ports for the coolant from the engine's cooling system. Coolant from the engine's cooling system passes through the deaerating tank where gases in the coolant are extracted from the coolant. The gases extracted from the coolant may include a combustible product, which is detected by a sensor coupled to a gas output port of the deaerating tank. If the combustible product sensor determines that a combustible product is present in the gases extracted from the coolant, the combustible product sensor outputs a signal indicating the same.

In another form, the present disclosure provides a method of testing an engine for a degraded head gasket. The method includes the step of detecting the presence of a combustible product in the coolant of a cooling system for the engine while the engine is running. The detection of the combustible product is facilitated by the deaerating of the engine coolant to separate any gases from the coolant. A combustible product sensor can be used to determine if the separated gases include the combustible product.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates a system with a carbon monoxide sensor for use with an engine according to the principles of the present disclosure;

FIG. 2 illustrates a combined sample chamber and sensor device with an accompanying electronic circuit according to the principles of the present disclosure;

FIG. 3 illustrates a system coupled to an engine within a test chamber according to the principles of the present disclosure; and

FIGS. 4A and 4B illustrate flowcharts for determining if a head gasket in an engine is degraded.

### DETAILED DESCRIPTION

Exemplary embodiments disclosed herein include a system and a method for detecting the presence of a combustible product in engine areas to be protected by a head gasket. A degraded head gasket, such as a leaking (e.g. a faulty seal), cracked, material decomposition, or otherwise breached head gasket often results in incomplete combustion in an associated combustion chamber. Combustible products include hydro-carbons, various oxides such as nitrogen oxide, carbon dioxide, carbon monoxide, water etc. A degraded head gasket can result in higher than desirable pressures within the combustion chamber. Combustible products can be forced out of the combustion chamber and thus can leak into the surrounding coolant jacket. Combustible products can leak into the cooling jacket when a head gasket is degraded. The exemplary embodiments disclosed herein include the monitoring of the engine's cooling system for the presence of one or more combustible products. A system for detecting the presence of combustible products can be implemented in a test rig incorporating an engine, an automotive test chamber or part of an on-board diagnostic capability built into a vehicle with an engine such as a car, truck, SUV.

Of the leaked combustible products, carbon monoxide, for example, is easily detected. Many solid state carbon monoxide sensors are effective, inexpensive and are commonly available. Therefore, head gasket degradation may be identified by using carbon monoxide sensors to detect carbon monoxide in the cooling system of the engine.

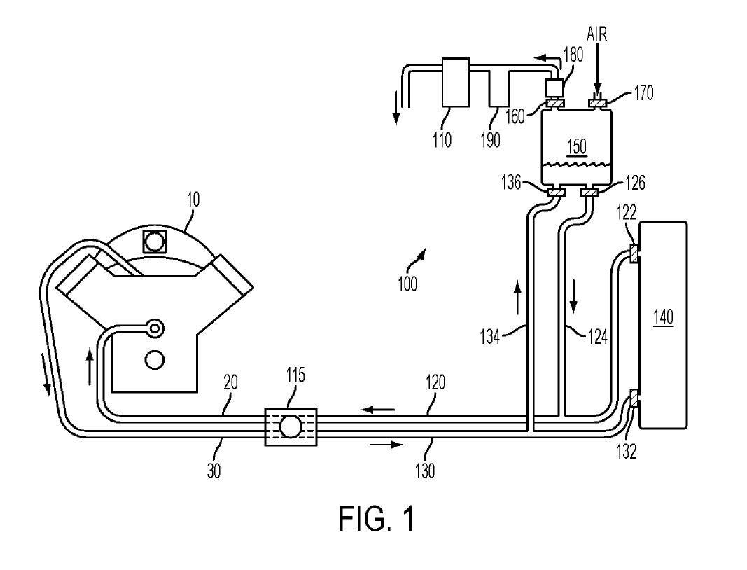

FIG. 1 illustrates a system 100, for e.g. a test rig, with a carbon monoxide sensor 110 for use with an engine 10 in accordance with a disclosed exemplary embodiment. Input cooling tubes 20 and output cooling tubes 30 connect engine 10 to test rig 100. In operation, the input and output cooling tubes 20, 30 can be coupled to a vehicle's radiator or other cooling device. As illustrated, the input and output cooling tubes 20, 30 are coupled via a bypass valve 115 to the test rig 100 that includes a cooling tower 140 and a deaerating tank 150. The cooling tower 140 provides a heat exchange system wherein warmed coolant delivered to the cooling tower 140 via coolant tube 130 may be cooled before being returned or input to the engine 10 via coolant tube 120. Coolant traveling through the coolant tubes 130, 120 enters and exits the cooling tower 140 via ports 132, 122.

The deaerating tank 150 is used to separate any air or combustion product gases that may be in the coolant as a result of a head gasket breach. The deaerating tank 150 is coupled to the coolant tubes 130, 120 of the test rig cooling tower 140 via separate coolant tubes 134, 124. Coolant tube 134 transports coolant to input port 136 located at the bottom of the deaerating tank 150. Coolant tube 124 transports coolant from output port 126 also located at the bottom of the deaerating tank 150. Because the input and output ports 136, 126 are located at the lower portions of the deaerating tank 150, coolant from the engine 10 enters the deaerating tank 150 from the bottom of the tank 150 and coolant returning to the engine 10 leaves the deaerating tank 150 from the bottom of the tank 150. As coolant from the engine 10 passes through the deaerating tank 150, gases in the coolant are released into the tank 150. The released gases exit the tank 150 through a gas output port 160 located at the top of the deaerating tank 150. The gases that exit through the gas output port 160 are analyzed to determine if a combustible product, like carbon monoxide, is among the released gases. An additional gas input port 170 is located at the top of the deaerating tank 150. The gas input port 170 allows air to be pumped into the deaerating tank 150 so as to maintain a desired pressure in the tank 150 and to prevent the coolant level in the tank 150 from reaching the top of the tank 150. In this way, no coolant is able to exit the deaerating tank 150 through the gas output port 160. In order to reduce the mixing of air input from the gas input port 170 and gases released from the coolant, the gas input port 170 is located at the opposite side of the top of the deaerating tank 150 as the gas output port 160.

In an exemplary embodiment, the gas output port 160 includes a small orifice that limits the amount of gas that can be output at any given time, thus limiting the size of the gas sample to be analyzed. The gas sample passes through a solenoid valve 180 and then to a sample chamber 190 before the gas sample is applied to the carbon monoxide sensor 110 for analysis. The solenoid valve 180 allows control of the gas output flow. The sample chamber 190 is used to contain a gas sample of sufficient volume for sensing by the carbon monoxide sensor 110. The sensor 110 analyzes the gas received from the deaerating tank 150 and then releases the sampled gas from the system 100. Gas samples flow past the sensor 110 in quantities suitable for adequate sensing by the carbon monoxide sensor 110. An example flow rate is 2400 cc/min.

Simple solid-state carbon monoxide detectors such as those that may be found in a home carbon monoxide warning product are more than adequate for use as the sensor 110 in the test rig 100. Because the sensor 110 need not have the ability to determine the amount of carbon monoxide, but need only determine the presence of carbon monoxide, simple inexpensive sensors may be used. The sensor 110 is coupled to or includes an electronic circuit which facilitates powering of the sensor 110 as well as sensor timing. While the solenoid valve 180 operates to control the timing and amount of gas output to the sensor 110, the electronic circuitry of the sensor 110 facilitates the timing specifics of when and how to sample the gas contained in the sample chamber 190. Timing schemes may be programmed into the circuit, or the sensor 110 may be configured to sense upon receipt of a control signal from an external source. Of course, the sensor 110 with its coupled electronic circuit must also be configured to output a signal representing the detection of carbon monoxide.

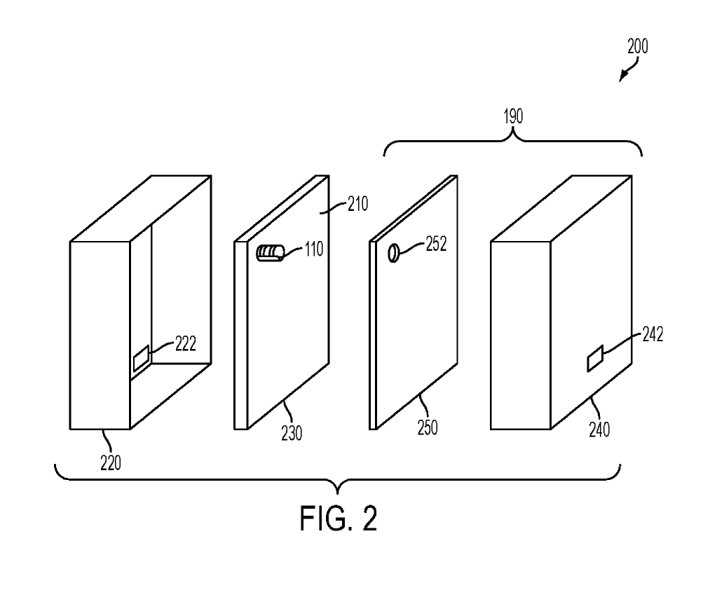

In an exemplary embodiment, FIG. 2 illustrates a combined sample chamber and sensor device 200 with an accompanying electronic circuit 210. For clarity, the combined sample chamber and sensor device 200 is illustrated in a disassembled state. For durability, the electronic circuit 210 is enclosed in a box 220 able to withstand the conditions of a test chamber. The sensor 110 with accompanying circuit 210 is attached to a circuit lid 230 and is inserted within the circuit box 220. Directly adjacent to the circuit lid 230 and sensor 110 input is the sample chamber 190 with an accompanying box 240 and lid 250. Combustion gases from the deaerating tank 150 are input to the sample chamber 190 through a port 242 in the box 240. The sample chamber 190 traps a sufficient amount of gas for analysis by the sensor 110, which has access to the sample chamber 190 through an aperture 252 in the sample chamber lid 250. Combustion gases are detected by the sensor 110 in the circuit lid 230 and are then output via an aperture 222 in the rear of the circuit box 220. Alternative sensor/sample chamber devices may be used.

By sealing the combustible product sensor, e.g. carbon monoxide sensor, 110 within the system 100, combustible product, e.g. carbon monoxide, analysis need not account for background levels of combustible product, carbon monoxide, present in the test chamber. Experiments with a known head gasket leak have shown that the signal-to-noise ratio (e.g., the strength of carbon monoxide measurements arising from a degraded head gasket compared to the strength of background carbon monoxide measurements) is high enough when using a carbon monoxide sensor 110 sealed within the test rig 100 so that corresponding background carbon monoxide measurements are not necessary. Conversely, by configuring the carbon monoxide sensor 110 to also take background carbon monoxide measurements, a desirable operation of the carbon monoxide sensor 110 at all times, even when there is no head gasket degradation, can be verified.

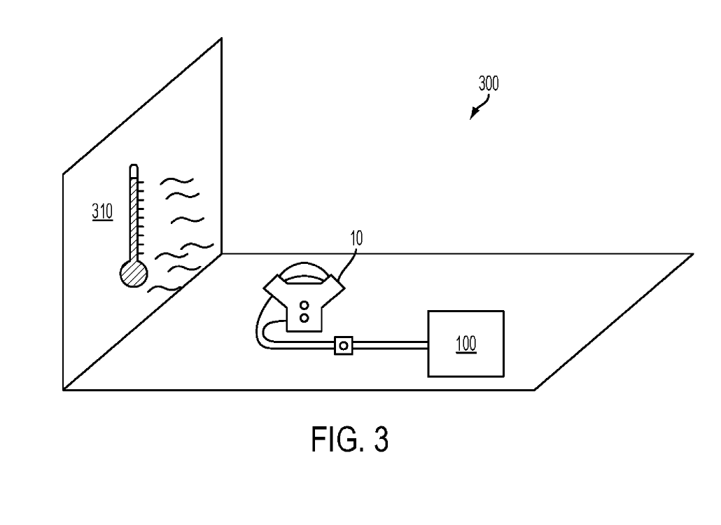

Also, by sealing the carbon monoxide sensor 110 and accompanying electronic circuit 210, sample chamber 190 and solenoid valve 180, the system 100 is able to be used in the harsh conditions of an automotive test chamber. FIG. 3 illustrates the system 100 coupled to an engine 10 inside a test chamber 300. The test chamber 300 includes harsh conditions such as extreme variations in heat 310. Other conditions such as exposure to corrosive substances may also be applied within the test chamber 300.

The sensor 110 can be configured to detect and/or analyze the gases from the deaerating tank 150 at periodic intervals. For example, measurements could be taken every 45 seconds. Alternatively, measurements could be taken to correspond with the operation schedule of the engine 10 in the test chamber so as to ensure that a variety of operating conditions are accounted for by the measurements.

While additional research might allow for a determination of the leakage rate of a head gasket based on the amount of carbon monoxide detected in the system 100, the current system 100 does not require this additional calculation. In an exemplary embodiment, once the carbon monoxide sensor 110 in the system 100 detects the presence of carbon monoxide from the coolant, the head gasket is assumed to be defective. Further tests (perhaps using different test equipment) may then be conducted, if desired, to confirm analysis and to determine the leakage flow rate from the head gasket.

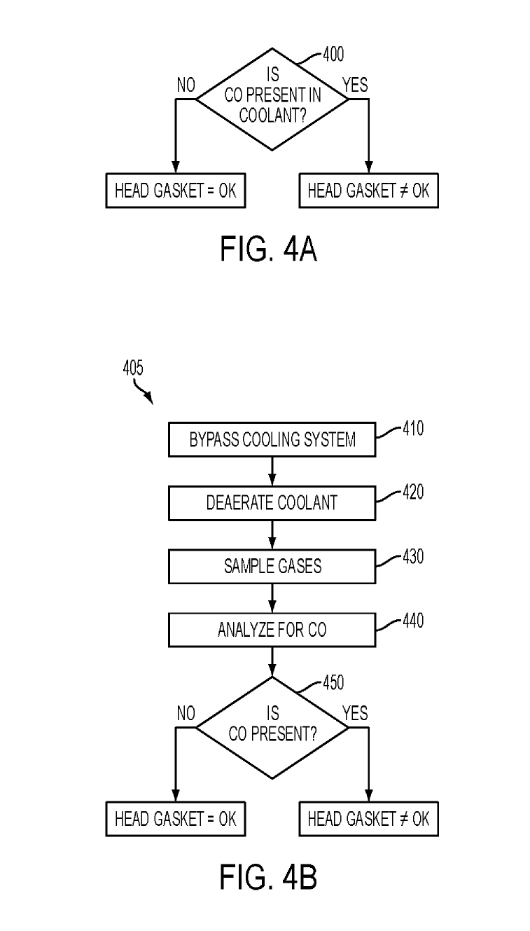

FIGS. 4A and 4B illustrate the disclosed process for determining if a head gasket is breached. In FIG. 4A, the question is asked at step 400: Is a combustible product, e.g. carbon monoxide, present in an engine's cooling system while the engine is running? If the answer is no, then the head gasket in the engine is assumed to be in an undegraded condition and sealed properly. If the answer is yes, then the head gasket in the engine is assumed to be defective or in some form of a degraded condition.

The details of answering the question from step 400 are illustrated in flowchart 405 in FIG. 4B. In flowchart 405, a system is used to bypass the engine's cooling system (step 410). Coolant from the engine's cooling system is passed through a deaerating tank for deaerating (step 420). The gases removed from the coolant are sampled (step 430) and analyzed using a combustible product, carbon monoxide, sensor to determine if carbon monoxide is present (step 440). If carbon monoxide is present, a signal is output from the carbon monoxide sensor (step 450).

In general, the test conditions that arise in a test cell occur automatically in response to a predetermined programmed test scenario. Similarly, the combustible product, carbon monoxide, periodic monitoring and analysis may also be automated in accordance with programmed instructions. As such, the electronic circuit 210 and any control circuits for either the sensor 110 or the solenoid valve 180 may be implemented in either hardware or software.

What is claimed is:

1. A system for detecting a degraded head gasket in an engine, said system comprising:
a cooling tower with first coolant input and output ports coupled to an engine's cooling system via a bypass valve;
a deaerating tank with second coolant input and output ports coupled to the first coolant input and output ports of the cooling tower, the deaerating tank also comprising gas input and output ports, the deaerating tank configured to extract a combustible product from coolant drawn from the engine's cooling system via the second coolant input and output ports; and
a combustible product sensor coupled to the gas output port of the deaerating tank and configured to detect the combustible product released from the coolant and output a signal if the combustible product is detected.

2. The system of claim 1, further comprising a timing valve coupled in between the combustible product sensor and the gas output port of the deaerating tank and configured to control the timing of gas output from the deaerating tank to the combustible product sensor.

3. The system of claim 2, wherein the timing valve comprises a solenoid.

4. The system of claim 2, wherein the timing valve is configured to periodically expose gas output from the deaerating tank to the combustible product sensor.

5. The system of claim 2, wherein the timing valve is configured to expose gas output from the deaerating tank to the combustible product sensor according to a schedule of engine operation.

6. The system of claim 2, further comprising a sample chamber coupled in between the combustible product sensor and the timing valve.

7. The system of claim 6, wherein the sample chamber and the combustible product sensor are sealed together.

8. The system of claim 6, wherein the sample chamber and the combustible product sensor are sealed within the system so as to contain and detect only gases received from the deaerating tank.

9. The system of claim 1, wherein the combustible product is carbon monoxide.

10. The system of claim 1, wherein the gas input port of the deaerating tank is configured to receive pressurized gases that do not include the combustible product.

11. The system of claim 1, wherein the system is configured to be used inside an automotive test chamber used to simulate engine operating conditions including hot, cold and corrosive conditions.

12. A method of testing an engine for a degraded head gasket, the method comprising:
detecting the presence of a combustible product in coolant of a cooling system for the engine, while the engine is running.

13. The method of claim 12, wherein said detecting step further comprises:
deaerating the coolant to separate gases from the coolant; and
determining if the separated gases include the combustible product, utilizing a combustible product sensor.

14. The method of claim 13, further comprising sampling the gases separated from the coolant at a regular interval.

15. The method of claim 13, further comprising sampling the gases separated from the coolant in accordance with a schedule of engine operation.

16. The method of claim 13, further comprising sealing the combustible product sensor so that only gases separated from the coolant are sensed for the combustible product.

17. The method of claim 13, wherein the deaerating and the determining steps occur in an automotive test chamber used to simulate engine operating conditions including hot, cold and corrosive conditions.

18. The method of claim 13, further comprising distinguishing between detected combustible product from a degraded head gasket and background levels of the combustible product.

19. The method of claim 13, further comprising periodically detecting background levels of the combustible product to ensure a desirable operation of the combustible product sensor.

20. The method of claim 13, wherein the combustible product is carbon monoxide.
